(19) United States
(12) Patent Application Publication
(10) Pub. No.: US 2024/0430913 A1
(43) Pub. Date: Dec. 26, 2024

(54) LCP PROCEDURE CONSIDERING INTER-UE COORDINATION SCHEMES

(71) Applicant: Lenovo (Singapore) Pte. Ltd., New Tech Park (SG)

(72) Inventors: Joachim Löhr, Wiesbaden (DE); Karthikeyan Ganesan, Kronberg im Taunus (DE); Prateek Basu Mallick, Dreieich (DE)

(21) Appl. No.: 18/707,502

(22) PCT Filed: Nov. 3, 2022
(86) PCT No.: PCT/IB2022/060620

§ 371 Date: May 3, 2024

Related U.S. Application Data
(60) Provisional application No. 63/275,348, filed on Nov. 3, 2021.

(51) Int. Cl. H04W 72/25; H04W 24/10

(52) U.S. Cl. CPC H04W 72/25; H04W 24/10

(57) ABSTRACT

Apparatuses, methods, and systems are disclosed for LCP procedure considering IUC schemes. An apparatus (600) includes a memory (610) and a processor (605) coupled to the memory (610). The processor (605) is configured to cause the apparatus (600) to determine a latency bound for transmission of a SL inter-UE coordination report via a MAC CE, maintain a report timer for transmitting the inter-UE coordination report via the MAC CE according to the determined latency bound, and transmit the inter-UE coordination information via the MAC CE based on the report timer.

### CROSS-REFERENCE TO RELATED APPLICATIONS

This application claims priority to U.S. Patent Application Ser. No. 63/275,348 entitled “LCP PROCEDURE CONSIDERING INTER-UE COORDINATION SCHEMES” and filed on Nov. 3, 2021, for Joachim Löhr, et al., which is incorporated herein by reference in its entirety.

### FIELD

The subject matter disclosed herein relates generally to wireless communications and more particularly relates to logical channel prioritization (“LCP”) procedure considering inter-user equipment (“UE”) coordination (“IUC”) schemes.

### BACKGROUND

In wireless networks, for cases that the physical layer (“PHY”) considers IUC information from a receiver UE during the sensing/resource selection procedure, medium access control (“MAC”) should use the candidate resources provided by PHY for the transmission of sidelink (“SL”) data to that receiving UE whose IUC information was considered. However, according to the current specified LCP procedure, the UE selects the destination for a SL transmission based on the highest logical channel priority. Therefore, it may happen that UE/MAC will select a different destination during LCP procedure than the destination whose IUC information was used during sensing/resource selection procedure by PHY.

### BRIEF SUMMARY

Disclosed are solutions for LCP procedure considering IUC schemes. The solutions may be implemented by apparatus, systems, methods, or computer program products.

In one embodiment, a first apparatus includes a memory and a processor coupled to the memory. In one embodiment, the processor is configured to cause the apparatus to determine a latency bound for transmission of a SL IUC report via a MAC CE, maintain a report timer for transmitting the IUC report via the MAC CE according to the determined latency bound, and transmit the IUC information via the MAC CE based on the report timer.

In one embodiment, a first method determines, at a UE apparatus, a latency bound for transmission of a SL IUC report via a MAC CE, maintains a report timer for transmitting the IUC report via the MAC CE according to the determined latency bound, and transmits the IUC information via the MAC CE based on the report timer.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a wireless communication system for LCP procedure considering IUC schemes;

FIG. 2 depicts an SL-CBR-PriorityTxConfigList information element:

FIG. 3 depicts an SL-CBR-CommonTxConfigList information element:

FIG. 4 depicts an example process flow for IUC schemes:

FIG. 5 is a diagram illustrating one embodiment of a new radio (“NR”) protocol stack:

FIG. 6 is a block diagram illustrating one embodiment of a UE apparatus that may be used for LCP procedure considering IUC schemes:

FIG. 7 is a block diagram illustrating one embodiment of a network apparatus that may be used for LCP procedure considering IUC schemes; and

FIG. 8 is a flowchart diagram illustrating one embodiment of a method for LCP procedure considering IUC schemes.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects.

For example, the disclosed embodiments may be implemented as a hardware circuit comprising custom very-large-scale integration (“VLSI”) circuits or gate arrays, off-the-shelf semiconductors such as logic chips, transistors, or other discrete components. The disclosed embodiments may also be implemented in programmable hardware devices such as field programmable gate arrays, programmable array logic, programmable logic devices, or the like. As another example, the disclosed embodiments may include one or more physical or logical blocks of executable code which may, for instance, be organized as an object, procedure, or function.

Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random-access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain or store a program for use by or in connection with an instruction execution system, apparatus, or device.

Code for carrying out operations for embodiments may be any number of lines and may be written in any combination of one or more programming languages including an object-oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”), wireless LAN (“WLAN”), or a wide area network (“WAN”), or the connection may be made to an external computer (for example, through the Internet using an Internet Service Provider (“ISP”).

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may; but do not necessarily, all refer to the same embodiment, but mean “one or more but not all embodiments” unless expressly specified otherwise. The terms “including.” “comprising.” “having,” and variations thereof mean “including but not limited to,” unless expressly specified otherwise. An enumerated listing of items does not imply that any or all of the items are mutually exclusive, unless expressly specified otherwise. The terms “a.” “an,” and “the” also refer to “one or more” unless expressly specified otherwise.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one and only one of any single item in the list. For example, “one of A, B and C” includes only A, only B or only C and excludes combinations of A, B and C. As used herein, “a member selected from the group consisting of A, B, and C,” includes one and only one of A, B, or C, and excludes combinations of A, B, and C.” As used herein, “a member selected from the group consisting of A, B, and C and combinations thereof” includes only A, only B, only C, a combination of A and B, a combination of B and C, a combination of A and C or a combination of A, B and C.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart diagrams and/or block diagrams.

The code may also be stored in a storage device that can direct a computer, other programmable data processing apparatus, or other devices to function in a particular manner, such that the instructions stored in the storage device produce an article of manufacture including instructions which implement the function/act specified in the flowchart diagrams and/or block diagrams.

The code may also be loaded onto a computer, other programmable data processing apparatus, or other devices to cause a series of operational steps to be performed on the computer, other programmable apparatus, or other devices to produce a computer implemented process such that the code which execute on the computer or other programmable apparatus provide processes for implementing the functions/acts specified in the flowchart diagrams and/or block diagrams.

The flowchart diagrams and/or block diagrams in the Figures illustrate the architecture, functionality, and operation of possible implementations of apparatuses, systems, methods, and program products according to various embodiments. In this regard, each block in the flowchart diagrams and/or block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

Generally, the present disclosure describes systems, methods, and apparatuses for LCP procedure considering IUC schemes. In certain embodiments, the methods may be performed using computer code embedded on a computer-readable medium. In certain embodiments, an apparatus or system may include a computer-readable medium containing computer-readable code which, when executed by a processor, causes the apparatus or system to perform at least a portion of the below described solutions.

In one embodiment, there are different IUC schemes, which may include:
Scheme 1a—preferred resource set:
Scheme 1b—non-preferred resource set; and
Scheme 2—expected/potential resource conflict indication on the reserved resources.

In Scheme 1a and Scheme 1b, a first UE, UE-A, sends a set of resources to a second UE, UE-B, based on explicit triggering information received from UE-B or autonomously triggered based on fulfilling certain conditions. Medium access control (“MAC”) control element (“CE”), PSSCH, sidelink control information (“SCI”), or the like are candidates for transmitting the set of resources based on explicit request or condition-based triggering. Scheme 2 may use physical sidelink feedback control channel (“PSFCH”) to signal the conflict on the reserved resources. In one embodiment, transmitting the set of resources by UE-A for scheme 1 incurs a large signaling overhead based on the sensing result of UE-A.

In one embodiment, congestion control mechanisms work by measuring the SL-RSSI within the congestion window defined by gNB. If the SL-RSSI is above a certain metric, transmission (“Tx”) parameter restrictions such as power reduction, MCS reduction, number of subchannels, or the like, may be limited for physical sidelink control channel (“PSCCH”) and physical sidelink shared channel (“PSSCH”) transmission.

In this disclosure, IUC schemes could be restricted based on the congestion control mechanism. During congestion control, schemes may need to be restricted to provide resources for PSCCH/PSSCH transmissions and not all schemes may be beneficial when the resource pool is congested as the number of available resources is limited for transmitting PSCCH, PSSCH, and IUC messages.

In general, in the solutions proposed herein, PHY indicates to MAC layer, the destination ID of the IUC information which was taken into account for sensing/resource selection. MAC will skip the first step of the LCP procedure and set the destination to the indicated destination ID from PHY. The MAC layer will further select the logical channels satisfying all the configured/predefined conditions, e.g., logical channel restrictions, among the logical channels belonging to the Destination indicated by PHY in order to generate a SL MAC packet data unit (“PDU”).

According to a prior art solution MAC would select the destination for a SL transmission according to the highest logical channel priority. For cases that the destination selected by MAC would not match the destination whose IUC information was considered during sensing/resource selection in PHY UE would need to redo the sensing/resource selection procedure and indicate a new set of candidate resources to MAC.

In one embodiment, MAC layer of the UE sets the Destination associated to a unicast to the destination ID of the IUC information taken into account during the sensing/resource selection procedure when performing an LCP procedure for generation a SL transport block. During the LCP procedure, UE selects the logical channels satisfying all the configured/predefined conditions, e.g., logical channel restrictions, among the logical channels belonging to the destination indicated by PHY to MAC in order to generate a SL MAC PDU.

In another embodiment, UE uses a predefined reference format for the generation of an IUC report for cases when the IUC report was triggered by the UE itself based on some predefined trigger conditions. UE generates the report including some predefined IUC type information, e.g., reporting of “preferred resources” and/or “not preferred resources,” according to the reference format. Furthermore, UE generates the IUC report for some predefined number of subchannels and a predefined priority and time period according to the reference format when autonomously triggering an IUC report to a destination.

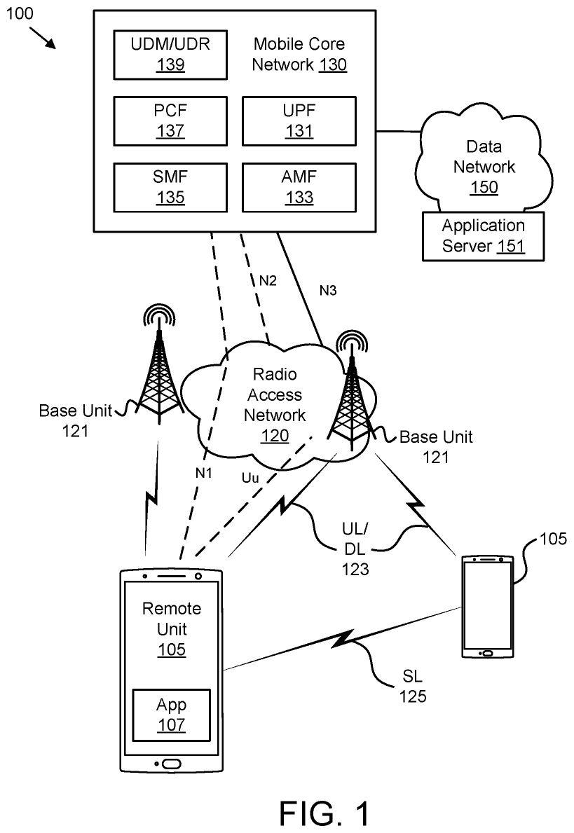

FIG. 1 depicts a wireless communication system 100 supporting LCP procedure considering IUC schemes, according to embodiments of the disclosure. In one embodiment, the wireless communication system 100 includes at least one remote unit 105, a radio access network (“RAN”) 120, and a mobile core network 130. The RAN 120 and the mobile core network 130 form a mobile communication network. The RAN 120 may be composed of a base unit 121 with which the remote unit 105 communicates using wireless communication links 115. Even though a specific number of remote units 105, base units 121, wireless communication links 115, RANs 120, and mobile core networks 130 are depicted in FIG. 1, one of skill in the art will recognize that any number of remote units 105, base units 121, wireless communication links 115, RANs 120, and mobile core networks 130 may be included in the wireless communication system 100.

In one implementation, the RAN 120 is compliant with the 5G system specified in the Third Generation Partnership Project (“3GPP”) specifications. For example, the RAN 120 may be a New Generation Radio Access Network (“NG-RAN”), implementing NR RAT and/or 3GPP Long-Term Evolution (“LTE”) RAT. In another example, the RAN 120 may include non-3GPP RAT (e.g., Wi-Fi® or Institute of Electrical and Electronics Engineers (“IEEE”) 802.11-family compliant WLAN). In another implementation, the RAN 120 is compliant with the LTE system specified in the 3GPP specifications. More generally, however, the wireless communication system 100 may implement some other open or proprietary communication network, for example Worldwide Interoperability for Microwave Access (“WiMAX”) or IEEE 802.16-family standards, among other networks. The present disclosure is not intended to be limited to the implementation of any particular wireless communication system architecture or protocol.

In one embodiment, the remote units 105 may include computing devices, such as desktop computers, laptop computers, personal digital assistants (“PDAs”), tablet computers, smart phones, smart televisions (e.g., televisions connected to the Internet), smart appliances (e.g., appliances connected to the Internet), set-top boxes, game consoles, security systems (including security cameras), vehicle on-board computers, network devices (e.g., routers, switches, modems), or the like. In some embodiments, the remote units 105 include wearable devices, such as smart watches, fitness bands, optical head-mounted displays, or the like. Moreover, the remote units 105 may be referred to as the UEs, subscriber units, mobiles, mobile stations, users, terminals, mobile terminals, fixed terminals, subscriber stations, user terminals, wireless transmit/receive unit (“WTRU”), a device, or by other terminology used in the art. In various embodiments, the remote unit 105 includes a subscriber identity and/or identification module (“SIM”) and the mobile equipment (“ME”) providing mobile termination functions (e.g., radio transmission, handover, speech encoding and decoding, error detection and correction, signaling and access to the SIM). In certain embodiments, the remote unit 105 may include a terminal equipment (“TE”) and/or be embedded in an appliance or device (e.g., a computing device, as described above).

The remote units 105 may communicate directly with one or more of the base units 121 in the RAN 120 via uplink (“UL”) and downlink (“DL”) communication signals. Furthermore, the UL and DL communication signals may be carried over the wireless communication links 123. Here, the RAN 120 is an intermediate network that provides the remote units 105 with access to the mobile core network 130.

In some embodiments, the remote units 105 communicate with an application server via a network connection with the mobile core network 130. For example, an application 107 (e.g., web browser, media client, telephone and/or Voice-over-Internet-Protocol (“VoIP”) application) in a remote unit 105 may trigger the remote unit 105 to establish a protocol data unit (“PDU”) session (or other data connection) with the mobile core network 130 via the RAN 120. The mobile core network 130 then relays traffic between the remote unit 105 and the application server (e.g., the content server 151 in the packet data network 150) using the PDU session. The PDU session represents a logical connection between the remote unit 105 and the User Plane Function (“UPF”) 131.

In order to establish the PDU session (or PDN connection), the remote unit 105 must be registered with the mobile core network 130 (also referred to as “attached to the mobile core network” in the context of a Fourth Generation (“4G”) system). Note that the remote unit 105 may establish one or more PDU sessions (or other data connections) with the mobile core network 130. As such, the remote unit 105 may have at least one PDU session for communicating with the packet data network 150, e.g., representative of the Internet. The remote unit 105 may establish additional PDU sessions for communicating with other data networks and/or other communication peers.

In the context of a 5G system (“5GS”), the term “PDU Session” a data connection that provides end-to-end (“E2E”) user plane (“UP”) connectivity between the remote unit 105 and a specific Data Network (“DN”) through the UPF 131. A PDU Session supports one or more Quality of Service (“QoS”) Flows. In certain embodiments, there may be a one-to-one mapping between a QoS Flow and a QoS profile, such that all packets belonging to a specific QoS Flow have the same 5G QOS Identifier (“5Q1”).

In the context of a 4G/LTE system, such as the Evolved Packet System (“EPS”), a Packet Data Network (“PDN”) connection (also referred to as EPS session) provides E2E UP connectivity between the remote unit and a PDN. The PDN connectivity procedure establishes an EPS Bearer, i.e., a tunnel between the remote unit 105 and a Packet Gateway (“PGW”, not shown) in the mobile core network 130. In certain embodiments, there is a one-to-one mapping between an EPS Bearer and a QoS profile, such that all packets belonging to a specific EPS Bearer have the same QoS Class Identifier (“QCI”).

The base units 121 may be distributed over a geographic region. In certain embodiments, a base unit 121 may also be referred to as an access terminal, an access point, a base, a base station, a Node-B (“NB”), an Evolved Node B (abbreviated as eNodeB or “eNB,” also known as Evolved Universal Terrestrial Radio Access Network (“E-UTRAN”) Node B), a 5G/NR Node B (“gNB”), a Home Node-B, a relay node, a RAN node, or by any other terminology used in the art. The base units 121 are generally part of a RAN, such as the RAN 120, that may include one or more controllers communicably coupled to one or more corresponding base units 121. These and other elements of radio access network are not illustrated but are well known generally by those having ordinary skill in the art. The base units 121 connect to the mobile core network 130 via the RAN 120.

The base units 121 may serve a number of remote units 105 within a serving area, for example, a cell or a cell sector, via a wireless communication link 123. The base units 121 may communicate directly with one or more of the remote units 105 via communication signals. Generally, the base units 121 transmit DL communication signals to serve the remote units 105 in the time, frequency, and/or spatial domain. Furthermore, the DL communication signals may be carried over the wireless communication links 123. The wireless communication links 123 may be any suitable carrier in licensed or unlicensed radio spectrum. The wireless communication links 123 facilitate communication between one or more of the remote units 105 and/or one or more of the base units 121. Note that during NR-U operation, the base unit 121 and the remote unit 105 communicate over unlicensed radio spectrum.

In one embodiment, two or more remote units 125 may be in direct communication with one another via a sidelink communication link 125. As used herein, sidelink is a networking topology that enables direct communication between two devices without the participation of a base station in the transmission and reception of data traffic.

In one embodiment, the mobile core network 130 is a 5GC or an Evolved Packet Core (“EPC”), which may be coupled to a packet data network 150, like the Internet and private data networks, among other data networks. A remote unit 105 may have a subscription or other account with the mobile core network 130. Each mobile core network 130 belongs to a single public land mobile network (“PLMN”). The present disclosure is not intended to be limited to the implementation of any particular wireless communication system architecture or protocol.

The mobile core network 130 includes several network functions (“NFs”). As depicted, the mobile core network 130 includes at least one UPF 131. The mobile core network 130 also includes multiple control plane (“CP”) functions including, but not limited to, an Access and Mobility Management Function (“AMF”) 133 that serves the RAN 120, a Session Management Function (“SMF”) 135, a Network Exposure Function (“NEF”), a Policy Control Function (“PCF”) 137, a Unified Data Management function (“UDM”) and a User Data Repository (“UDR”).

The UPF(s) 131 is responsible for packet routing and forwarding, packet inspection, QoS handling, and external PDU session for interconnecting Data Network (“DN”), in the 5G architecture. The AMF 133 is responsible for termination of NAS signaling, NAS ciphering & integrity protection, registration management, connection management, mobility management, access authentication and authorization, security context management. The SMF 135 is responsible for session management (i.e., session establishment, modification, release), remote unit (i.e., UE) IP address allocation & management, DL data notification, and traffic steering configuration for UPF for proper traffic routing.

The NEF is responsible for making network data and resources easily accessible to customers and network partners. Service providers may activate new capabilities and expose them through APIs. These APIs allow third-party authorized applications to monitor and configure the network's behavior for a number of different subscribers (i.e., connected devices with different applications). The PCF 137 is responsible for unified policy framework, providing policy rules to CP functions, access subscription information for policy decisions in UDR.

The UDM is responsible for generation of Authentication and Key Agreement (“AKA”) credentials, user identification handling, access authorization, subscription management. The UDR is a repository of subscriber information and can be used to service a number of network functions. For example, the UDR may store subscription data, policy-related data, subscriber-related data that is permitted to be exposed to third party applications, and the like. In some embodiments, the UDM is co-located with the UDR, depicted as combined entity “UDM/UDR” 139.

In various embodiments, the mobile core network 130 may also include an Authentication Server Function (“AUSF”) (which acts as an authentication server), a Network Repository Function (“NRF”) (which provides NF service registration and discovery, enabling NFs to identify appropriate services in one another and communicate with each other over Application Programming Interfaces (“APIs”)), or other NFs defined for the 5GC. In certain embodiments, the mobile core network 130 may include an authentication, authorization, and accounting (“AAA”) server.

In various embodiments, the mobile core network 130 supports different types of mobile data connections and different types of network slices, wherein each mobile data connection utilizes a specific network slice. Here, a “network slice” refers to a portion of the mobile core network 130 optimized for a certain traffic type or communication service. A network instance may be identified by a single-network slice selection assistance information (“S-NSSAI,”) while a set of network slices for which the remote unit 105 is authorized to use is identified by network slice selection assistance information (“NSSAI”).

Here, “NSSAI” refers to a vector value including one or more S-NSSAI values. In certain embodiments, the various network slices may include separate instances of network functions, such as the SMF 135 and UPF 131. In some embodiments, the different network slices may share some common network functions, such as the AMF 133. The different network slices are not shown in FIG. 1 for ease of illustration, but their support is assumed. Where different network slices are deployed, the mobile core network 130 may include a Network Slice Selection Function (“NSSF”) which is responsible for selecting of the Network Slice instances to serve the remote unit 105, determining the allowed NSSAI, determining the AMF set to be used to serve the remote unit 105.

Although specific numbers and types of network functions are depicted in FIG. 1, one of skill in the art will recognize that any number and type of network functions may be included in the mobile core network 130. Moreover, in an LTE variant where the mobile core network 130 comprises an EPC, the depicted network functions may be replaced with appropriate EPC entities, such as a Mobility Management Entity (“MME”), a Serving Gateway (“SGW”), a PGW, a Home Subscriber Server (“HSS”), and the like. For example, the AMF 133 may be mapped to an MME, the SMF 135 may be mapped to a control plane portion of a PGW and/or to an MME, the UPF 131 may be mapped to an SGW and a user plane portion of the PGW, the UDM/UDR 139 may be mapped to an HSS, etc.

While FIG. 1 depicts components of a 5G RAN and a 5G core network, the described embodiments apply to other types of communication networks and RATs, including IEEE 802.11 variants, Global System for Mobile Communications (“GSM”, i.e., a 2G digital cellular network), General Packet Radio Service (“GPRS”), UMTS, LTE variants, CDMA 2000, Bluetooth, Zig Bee, Sigfox, and the like.

In the following descriptions, the term “gNB” is used for the base station but it is replaceable by any other radio access node, e.g., RAN node, eNB, Base Station (“BS”), Access Point (“AP”), NR, etc. Further the operations are described mainly in the context of 5G NR. However, the proposed solutions/methods are also equally applicable to other mobile communication systems supporting LCP procedure considering IUC schemes.

As background, regarding sidelink congestion control in sidelink resource allocation mode 2, if a UE is configured with higher layer parameter sl-CR-Limit and transmits PSSCH in slot n, the UE shall ensure the following limits for any priority value k:

$${\sum }_{i \geq k} C R ( i ) \leq C {R}_{Limit} ( k )$$

where CR (i) is the CR evaluated in slot n-N for the PSSCH transmissions with ‘Priority’ field in the SCI set to i, and CR_{Limit} (k) corresponds to the high layer parameter sl-CR-Limit that is associated with the priority value k and the CBR range which includes the CBR measured in slot n-N, where Nis the congestion control processing time.

The congestion control processing time N is based on u of Table 1 and Table 2 for UE processing capability 1 and 2 respectively, where u corresponds to the subcarrier spacing of the sidelink channel with which the PSSCH is to be transmitted. A UE shall only apply a single processing time capability in sidelink congestion control.

| μ | Congestion control processing time N [slots] |
|---|---|
| 0 | 2 |
| 1 | 2 |
| 2 | 4 |
| 3 | 8 |

| μ | Congestion control processing time N [slots] |
|---|---|
| 0 | 2 |
| 1 | 4 |
| 2 | 8 |
| 3 | 16 |

It is up to UE implementation how to meet the above limits, including dropping the transmissions in slot n.

In one embodiment, congestion control can restrict the values of at least the following PSSCH/PSCCH TX parameters per resource pool:
Range of MCS for a given MCS table supported within the resource pool
Range of number of sub-channels
Upper bound of number of (re) transmissions-already agreed in mode 2 AI
Upper bound of TX power (including zero TX power)

In one embodiment, congestion control can set an upper bound on channel occupancy ratio (“CR”), CRₗᵢₘᵢₜ. Ranges/bounds of the transmission parameters and CRₗᵢₘᵢₜ are functions of QoS and CBR. In addition to congestion control (in use or not in use), the above parameters can be restricted by reusing the same mechanism as in LTE.

In one embodiment, in addition to congestion control (in use or not in use), the following PSSCH/PSCCH TX parameters per resource pool can be restricted by reusing the same mechanism as in LTE:
Range of MCS for a given MCS table supported within the resource pool
Range of number of sub-channels
Upper bound of number of (re) transmissions

Regarding 3GPP TS 38.331-Sidelink congestion control:

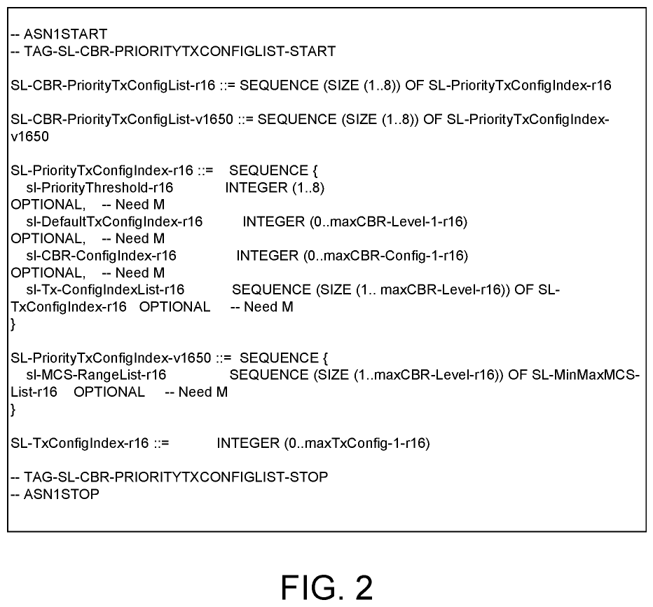

The IE SL-CBR-PriorityTxConfigList, shown in FIG. 2, indicates the mapping between PSSCH transmission parameter (such as MCS, PRB number, retransmission number, CR limit) sets by using the indexes of the configurations provided in sl-CBR-PSSCH-TxConfigList, CBR ranges by an index to the entry of the CBR range configuration in sl-CBR-RangeConfigList, and priority ranges. It also indicates the default PSSCH transmission parameters to be used when CBR measurement results are not available, and MCS range for the MCS tables used in the resource pool.

SL-CBR-PriorityTxConfigList field descriptions
sl-CBR-ConfigIndex
Indicates the CBR ranges to be used by an index to
the entry of the CBR range configuration in sl-CBR-
RangeConfigList.
sl-DefaultTxConfigIndex
Indicates the PSSCH transmission parameters to be
used by the UEs which do not have available CBR
measurement results, by means of an index to the
corresponding entry in tx-ConfigIndexList. Value 0
indicates the first entry in tx-ConfigIndexList.
The field is ignored if the UE has available CBR
measurement results.
sl-MCS-RangeList
Indicates the minimum MCS value and maximum
MCS value for the associated MCS table(s). UE shall
ignore the minimum MCS value and maximum
MCS value used for table of 64QAM indicated in SL-
CBR-PriorityTxConfigList-r16 if SL-CBR-
PriorityTxConfigList-v1650 is present.
sl-PriorityThreshold
Indicates the upper bound of priority range which is
associated with the configurations in sl-CBR-
ConfigIndex and in sl-Tx-ConfigIndexList. The
upper bounds of the priority ranges are configured in
ascending order for consecutive entries of SL-
PriorityTxConfigIndex in SL-CBR-PriorityTxConfigList.
For the first entry of SL-PriorityTxConfigIndex,
the lower bound of the priority range is 1.
SL-CBR-PriorityTxConfigList-v1650
If included, it includes the same number of entries,
and listed in the same order, as in SL-CBR-
PriorityTxConfigList-r16.

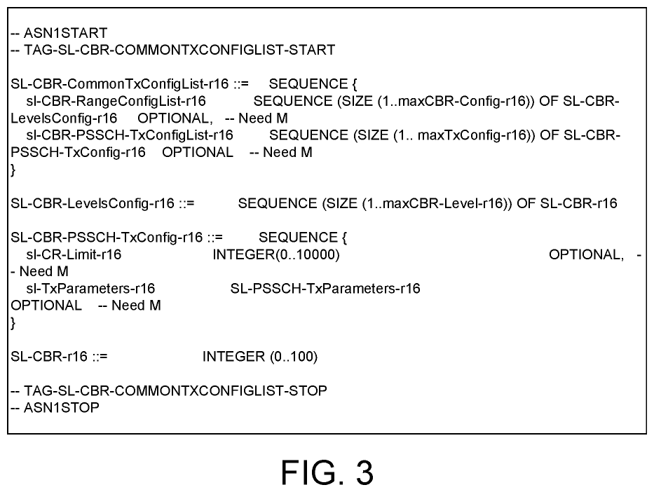

The IE SL-CBR-CommonTxConfigList, shown in FIG. 3, indicates the list of PSSCH transmission parameters (such as MCS, sub-channel number, retransmission number, CR limit) in sl-CBR-PSSCH-TxConfigList, and the list of CBR ranges in sl-CBR-RangeConfigList, to configure congestion control to the UE for sidelink communication.

SL-CBR-CommonTxConfigList field descriptions
sl-CBR-RangeConfigList
Indicates the list of CBR ranges. Each entry of the list
indicates in SL-CBR-LevelsConfig the upper bound of
the CBR range for the respective entry. The upper
bounds of the CBR ranges are configured in ascending
order for consecutive entries of sl-CBR-RangeConfigList.
For the first entry of sl-CBR-RangeConfigList the
lower bound of the CBR range is 0. Value 0 corresponds
to 0, value 1 to 0.01, value 2 to 0.02, and so on.
sl-CR-Limit
Indicates the maximum limit on the occupancy ratio.
Value 0 corresponds to 0, value 1 to 0.0001, value 2 to
0.0002, and so on (i.e., in steps of 0.0001) until
value 10000, which corresponds to 1.
sl-CBR-PSSCH-TxConfigList
Indicates the list of available PSSCH transmission
parameters (such as MCS, sub-channel number,
retransmission number and CR limit) configurations.
sl-TxParameters
Indicates PSSCH transmission parameters.

Regarding Sidelink Rel17 agreements on the IUC, in one embodiment, the schemes of IUC in Mode 2 are categorized as being based on the following types of “A set of resources” sent by UE-A to UE-B:
UE-A sends to UE-B the set of resources preferred for UE-B's transmission 1. e.g., based on its sensing result.
UE-A sends to UE-B the set of resources not preferred for UE-B's transmission 1. e.g., based on its sensing result and/or expected/potential resource conflict.
UE-A sends to UE-B the set of resource where the resource conflict is detected

In one embodiment, for IUC Scheme 1, the coordination information sent from UE-A to UE-B is the set of resources preferred and/or non-preferred for UE-B's transmission.

In one embodiment, for IUC Scheme 2, the coordination information sent from UE-A to UE-B is the presence of expected/potential and/or detected resource conflict on the resources indicated by UE-B's SCI.

In one embodiment, when UE-B receives the IUC information from UE-A, consider at least one of the following options for UE-Bs to take it into account in the resource (re)-selection for its own transmission:

For scheme 1:
Option 1-1: UE-B's resource(s) to be used for its transmission resource (re)-selection is based on both UE-B's sensing result (if available) and the received coordination information
Option 1-2: UE-B's resource(s) to be used for its transmission resource (re)-selection is based only on the received coordination information
Option 1-3: UE-B's resource(s) to be re-selected based on the received coordination information
Option 1-4: UE-B's resource(s) to be used for its transmission resource (re)-selection is based on the received coordination information

For scheme 2:
Option 2-1: UE-B can determine resource(s) to be re-selected based on the received coordination information
Option 2-2: UE-B can determine a necessity of retransmission based on the received coordination information

In one embodiment, for scheme 1, the following IUC information signaling from UE-A is supported:
Set of resources preferred for UE-B's transmission
Set of resources non-preferred for UE-B's transmission

In one embodiment, for scheme 2, the following IUC information signaling from UE-A is supported:
Presence of expected/potential resource conflict on the resources indicated by UE-B's SCI

In one embodiment, in scheme 1, the following is supported for UE(s) to be UE-A(s)/UE-B(s) in the IUC information transmission triggered by an explicit request in Mode 2:
A UE that sends an explicit request for IUC information can be UE-B
A UE that received an explicit request from UE-B and sends IUC information to the UE-B can be UE-A.

At least a destination UE of a TB transmitted by UE-B can be UE A
The above feature can be enabled or disabled or controlled by (pre-) configuration

In one embodiment, in scheme 1, the following is supported for UE(s) to be UE-A(s)/UE-B(s) in the IUC information transmission triggered by a condition other than explicit request reception in Mode 2:
A UE that satisfies the condition mentioned in the main bullet and sends IUC information is UE-A.
A UE that received IUC information from UE-A and uses it for resource (re-) selection is UE-B
The above feature can be enabled or disabled or controlled by (pre-) configuration

In one embodiment, in scheme 2, at least the following is supported for UE(s) to be UE-A(s)/UE-B(s) in the IUC transmission triggered by a detection of expected/potential resource conflict(s) in Mode 2:
A UE that transmitted PSCCH/PSSCH with SCI indicating reserved resource(s) to be used for its transmission, received IUC information from UE-A indicating expected/potential resource conflict(s) for the reserved resource(s), and uses it to determine resource re-selection is UE-B
A UE that detects expected/potential resource conflict(s) on resource(s) indicated by UE-B's SCI sends IUC information to UE-B, subject to satisfy one of the following conditions, is UE-A.
At least a destination UE of one of the conflicting TBs, i.e., TBs to be transmitted in the expected/potential conflicting resource(s).
Whether a non-destination UE of a TB transmitted by UE-B can be UE-A is (pre-) configured

In one embodiment, in scheme 2, the following UE-B's behavior in its resource (re) selection is supported when it receives IUC information from UE-A:
UE-B can determine resource(s) to be re-selected based on the received coordination information
UE-B can reselect resource(s) reserved for its transmission when expected/potential resource conflict on the resource(s) is indicated

In one embodiment, in scheme 1, at least following UE-B's behavior in its resource (re-) selection is supported when it receives IUC information from UE-A:

For preferred resource set, the following two options are supported:
Option A): UE-B's resource(s) to be used for its transmission resource (re-) selection is based on both UE-B's sensing result (if available) and the received coordination information
UE-B uses in its resource (re-) selection, resource(s) belonging to the preferred resource set in combination with its own sensing result
UE-B uses in its resource (re-) selection, resource(s) not belonging to the preferred resource set when condition(s) are met
This option is supported when UE-B performs sensing/resource exclusion
Option B): UE-B's resource(s) to be used for its transmission resource (re-) selection is based only on the received coordination information
UE-B uses in its resource (re-) selection, resource(s) belonging to the preferred resource set
This option is supported at least when UE-B does not support sensing/resource exclusion

For non-preferred resource set, UE-B's resource(s) to be used for its transmission resource (re-) selection is based on both UE-B's sensing result (if available) and the received coordination information. UE-B excludes in its resource (re-) selection, resource(s) overlapping with the non-preferred resource set.

In one embodiment, in scheme 2, at least the following is supported to determine IUC information:
Among resource(s) indicated by UE-B's SCI, UE-A considers that expected/potential resource conflict occurs on the resource(s) satisfying at least one of the following condition(s):
Condition 2-A-1: Other UE's reserved resource(s) identified by UE-A are fully/partially overlapping with resource(s) indicated by UE-B's SCI in time-and-frequency
Condition 2-A-2: Resource(s) (e.g., slot(s)) where UE-A, when it is intended receiver of UE-B, does not expect to perform SL reception from UE-B due to half duplex operation

In one embodiment, in scheme 1, at least the following is supported to determine IUC information of preferred resource set: UE-A considers any resource(s) satisfying all the following condition(s) as set of resource(s) preferred for UE-B's transmission.

Condition 1-A-1: Resource(s) excluding those overlapping with reserved resource(s) of other UE identified by UE-A whose reference signal received power (“RSRP”) measurement is larger than a RSRP threshold.

Resource(s) excluding slot(s) where UE-A, when it is intended receiver of UE-B, does not expect to perform SL reception from UE-B. Resource(s) satisfying UE-B's traffic requirement (if available).

In one embodiment, in scheme 1, at least the following is supported to determine IUC information of non-preferred resource set: UE-A considers any resource(s) satisfying at least one of the following condition(s) as set of resource(s) non-preferred for UE-B's transmission.

Condition 1-B-1: Reserved resource(s) of other UE identified by UE-A from other UEs' SCI (including priority field) and RSRP measurement.

Resource(s) (e.g., slot(s)) where UE-A, when it is intended receiver of UE-B, does not expect to perform SL reception from UE-B.

In one embodiment, for Scheme 2, PSFCH format 0 is used to convey the presence of expected/potential resource conflict on reserved resource(s) indicated by UE-B's SCI.

In one embodiment, for Condition 2-A-1 of Scheme 2, down-select one or more of the following additional criteria to determine resource(s) where expected/potential resource conflict occurs:
Option 1: The resource(s) are fully/partially overlapping in time-and-frequency with other UE's reserved resource(s) whose RSRP measurement is larger than an RSRP threshold according to the priorities included in the SCI.
Option 2: The resource(s) are fully/partially overlapping in time-and-frequency with other UE's reserved resource(s) whose RSRP measurement is within a (pre) configured RSRP threshold compared to the RSRP measurement of UE-B's reserved resource.
Option 3: The resource(s) are fully/partially overlapping in time-and-frequency with other UE's reserved resource(s) and the other UE is within a distance threshold of UE-B as determined by both UEs' SCIs.
Option 4: The resource(s) are fully/partially overlapping in time-and-frequency with other UE's reserved resource(s) whose RSRP measurement is larger a (pre) configured RSRP threshold compared to the RSRP measurement of UE-B's reserved resource.

In one embodiment, for Condition 1-B-1 of Scheme 1, the following two options are supported:
Option 1: Reserved resource(s) of other UE(s) identified by UE-A whose RSRP measurement is larger than a (pre) configured RSRP threshold which is determined by at least priority value indicated by SCI of the UE(s).
Option 2: Reserved resource(s) of other UE identified by UE-A whose RSRP measurement is smaller than a (pre) configured RSRP threshold which is determined by at least priority value indicated by SCI of the UE(s) when UE-A is a destination of a TB transmitted by the UE(s).

In one embodiment, for Scheme 1 with non-preferred resource set, support following condition: Condition 1-B-2: Resource(s) (e.g., slot(s)) where UE-A, when it is intended receiver of UE-B, does not expect to perform SL reception from UE-B due to half duplex operation.

In one embodiment, for Condition 1-A-1 of Scheme 1, the set of resources preferred for UE-B's transmission is a form of candidate single-slot resource as specified in Rel-16 TS 38.214 Section 8.1.4 (incorporated herein by reference).

When the IUC information transmission is triggered by UE-B's explicit request, the candidate single-slot resource(s) are determined in the same way according to Rel-16 TS 38.214 Section 8.1.4 with at least following parameters provided by signaling from UE-B:
Priority value to be used for PSCCH/PSSCH transmission, replaces prio_TX
Number of sub-channels to be used for PSSCH/PSCCH transmission in a slot, replaces L_subCH.
Resource reservation interval, replaces P_rsvp_TX

For Scheme 1 with preferred resource set, support following condition:

Condition 1-A-2: Resource(s) excluding slot(s) where UE-A, when it is intended receiver of UE-B, does not expect to perform SL reception from UE-B due to half duplex operation. This can be disabled by RRC (pre-) configuration.

For allocating PSFCH resources in Scheme 2, at least following can be (pre) configured separately from those for SL HARQ-ACK feedback: set of PRBs for PSFCH transmission/reception (sl-PSFCH-RB-Set).

For Scheme 2, an index of a PSFCH resource for IUC information transmission is determined in the same way according to Rel-16 TS 38.213 Section 16.3 with at least following modification:
P_ID is L1-Source ID indicated by UE-B's SCI
M_ID is 0

In one embodiment (according to TS 38.321, which is incorporated herein by reference), for PDU(s) associated with one SCI, MAC shall consider only logical channels with the same Source Layer-2 ID-Destination Layer-2 ID pair for one of unicast, groupcast and broadcast which is associated with the pair. Multiple transmissions for different Sidelink processes are allowed to be independently performed in different PSSCH durations.

In one embodiment, the sidelink Logical Channel Prioritization procedure is applied whenever a new transmission is performed. RRC controls the scheduling of sidelink data by signalling for each logical channel:
sl-Priority where an increasing priority value indicates a lower priority level:
sl-PrioritisedBitRate which sets the sidelink Prioritized Bit Rate (sPBR):
sl-BucketSizeDuration which sets the sidelink Bucket Size Duration (sBSD).

RRC additionally controls the LCP procedure by configuring mapping restrictions for each logical channel:
sl-configuredGrantTypelAllowed which sets whether a configured grant Type 1 can be used for sidelink transmission:
sl-AllowedCG-List which sets the allowed configured grant(s) for sidelink transmission:
sl-HARQ-FeedbackEnabled which sets whether the logical channel is allowed to be multiplexed with logical channel(s) with sl-HARQ-FeedbackEnabled set to enabled or disabled.

The following UE variable is used for the Logical channel prioritization procedure:
SBj which is maintained for each logical channel j.

The MAC entity shall initialize SBj of the logical channel to zero when the logical channel is established.

For each logical channel j, the MAC entity shall:
1> increment SBj by the product sPBR×T before every instance of the LCP procedure, where T is the time elapsed since SBj was last incremented:
1> if the value of SBj is greater than the sidelink bucket size (i.e. sPBR×sBSD):
2> set SBj to the sidelink bucket size.

NOTE: The exact moment(s) when the UE updates SBj between LCP procedures is up to UE implementation, as long as SBj is up to date at the time when a grant is processed by LCP.

In one embodiment, the MAC entity shall for each SCI corresponding to a new transmission:
1> select a Destination associated to one of unicast, groupcast and broadcast, having at least one of the MAC CE and the logical channel with the highest priority, among the logical channels that satisfy all the following conditions and MAC CE(s), if any, for the SL grant associated to the SCI:
2> SL data is available for transmission; and
2> SBj>0, in case there is any logical channel having SBj>0; and
2> sl-configuredGrantType1Allowed, if configured, is set to true in case the SL grant is a Configured Grant Type 1; and
2> sl-AllowedCG-List, if configured, includes the configured grant index associated to the SL grant; and
2> sl-HARQ-FeedbackEnabled is set to disabled, if PSFCH is not configured for the SL grant associated to the SCI.
NOTE 1: If multiple Destinations have the logical channels satisfying all conditions above with the same highest priority or if multiple Destinations have either the MAC CE and/or the logical channels satisfying all conditions above with the same priority as the MAC CE, which Destination is selected among them is up to UE implementation.
1> select the logical channels satisfying all the following conditions among the logical channels belonging to the selected Destination:
2> SL data is available for transmission; and. 2> sl-configuredGrantType1Allowed, if configured, is set to true in case the SL grant is a Configured Grant Type 1; and.
2> sl-AllowedCG-List, if configured, includes the configured grant index associated to the SL grant; and
3> if PSFCH is configured for the sidelink grant associated to the SCI:
4> sl-HARQ-FeedbackEnabled is set to enabled, if sl-HARQ-FeedbackEnabled is set to enabled for the highest priority logical channel satisfying the above conditions: or
4> sl-HARQ-FeedbackEnabled is set to disabled, if sl-HARQ-FeedbackEnabled is set to disabled for the highest priority logical channel satisfying the above conditions.
3> else:
4> sl-HARQ-FeedbackEnabled is set to disabled.
NOTE 2: sl-HARQ-FeedbackEnabled is set to disabled for the transmission of a MAC PDU only carrying CSI reporting MAC CE.

The MAC entity shall for each SCI corresponding to a new transmission:
1> allocate resources to the logical channels as follows:
2> logical channels selected in clause 5.22.1.4.1.2 for the SL grant with SBj>0 are allocated resources in a decreasing priority order. If the sPBR of a logical channel is set to infinity, the MAC entity shall allocate resources for all the data that is available for transmission on the logical channel before meeting the sPBR of the lower priority logical channel(s);
2> decrement SBj by the total size of MAC SDUs served to logical channel j above:
2> if any resources remain, all the logical channels selected in clause 5.22.1.4.1.2 are served in a strict decreasing priority order (regardless of the value of SBj) until either the data for that logical channel or the SL grant is exhausted, whichever comes first. Logical channels configured with equal priority should be served equally.
NOTE: The value of SBj can be negative.

The UE shall also follow the rules below during the SL scheduling procedures above:
the UE should not segment an RLC SDU (or partially transmitted SDU or retransmitted RLC PDU) if the whole SDU (or partially transmitted SDU or retransmitted RLC PDU) fits into the remaining resources of the associated MAC entity:
if the UE segments an RLC SDU from the logical channel, it shall maximize the size of the segment to fill the grant of the associated MAC entity as much as possible:
the UE should maximize the transmission of data:
if the MAC entity is given a sidelink grant size that is equal to or larger than 12 bytes while having data available and allowed (according to clause 5.22.1.4.1) for transmission, the MAC entity shall not transmit only padding:
A logical channel configured with sl-HARQ-FeedbackEnabled set to enabled and a logical channel configured with sl-HARQ-FeedbackEnabled set to disabled cannot be multiplexed into the same MAC PDU.

The MAC entity shall not generate a MAC PDU for the HARQ entity if the following conditions are satisfied:
there is no Sidelink CSI Reporting MAC CE generated for this PSSCH transmission as specified in clause 5.22.1.7; and.
the MAC PDU includes zero MAC SDUs.

Logical channels shall be prioritized in accordance with the following order (highest priority listed first):
data from SCCH;
Sidelink CSI Reporting MAC CE;
data from any STCH.

In one embodiment, the Sidelink Channel State Information (“SL-CSI”) reporting procedure is used to provide a peer UE with sidelink channel state information as specified in clause 8.5 of TS 38.214.

RRC configures the following parameters to control the SL-CSI reporting procedure:
sl-LatencyBoundCSI-Report, which is maintained for each PC5-RRC connection.

The MAC entity maintains a sl-CSI-ReportTimer for each pair of the Source Layer-2 ID and the Destination Layer-2 ID corresponding to a PC5-RRC connection. sl-CSI-ReportTimer is used for a SL-CSI reporting UE to follow the latency requirement signalled from a CSI triggering UE. The value of sl-CSI-ReportTimer is the same as the latency requirement of the SL-CSI reporting in sl-Latency Bound CSI-Report configured by RRC.

The MAC entity shall for each pair of the Source Layer-2 ID and the Destination Layer-2 ID corresponding to a PC5-RRC connection which has been established by upper layers:
1> if the SL-CSI reporting has been triggered by a SCI and not cancelled:
2> if the sl-CSI-ReportTimer for the triggered SL-CSI reporting is not running:
3> start the sl-CSI-ReportTimer.
2> if the sl-CSI-ReportTimer for the triggered SL-CSI reporting expires:
3> cancel the triggered SL-CSI reporting.
2> else if the MAC entity has SL resources allocated for new transmission and the SL-SCH resources can accommodate the SL-CSI reporting MAC CE and its subheader as a result of logical channel prioritization:
3> instruct the Multiplexing and Assembly procedure to generate a Sidelink CSI Reporting MAC CE as defined in clause 6.1.3.35;
3> stop the sl-CSI-ReportTimer for the triggered SL-CSI reporting:
3> cancel the triggered SL-CSI reporting.
2> else if the MAC entity has been configured with Sidelink resource allocation mode 1:
3> trigger a Scheduling Request.

NOTE: The MAC entity configured with Sidelink resource allocation mode 1 may trigger a Scheduling Request if transmission of a pending SL-CSI reporting with the sidelink grant(s) cannot fulfil the latency requirement associated to the SL-CSI reporting.

For the proposed solution, in the following the term eNB/gNB is used for the base station but it is replaceable by any other radio access node, e.g., BS, CNB, gNB, AP, NR etc. Further the proposed methods are described mainly in the context of 5G NR. However, the proposed solutions/methods are also equally applicable to other mobile communication systems supporting serving cells/carriers being configured for Sidelink Communication over PC5 interface.

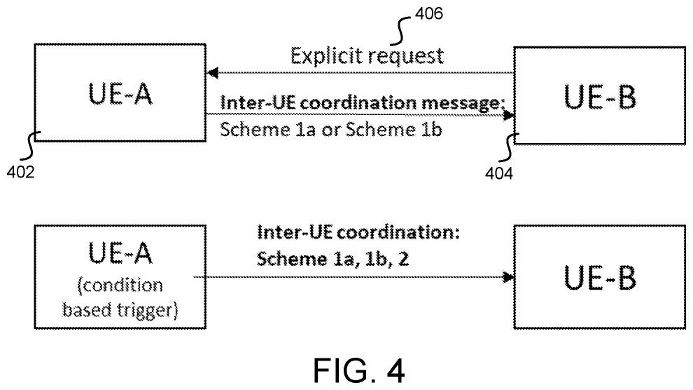

According to a first embodiment, a UE sets the destination associated to a unicast to the destination ID of the IUC information taken into account during the sensing/resource selection procedure when performing an LCP procedure for generation of a SL transport block. During the LCP procedure, the UE selects the logical channels satisfying all the configured/predefined conditions, e.g., logical channel restrictions, among the logical channels belonging to the Destination set in the first step in order to generate a SL MAC PDU. According to one implementation of the embodiment, the physical layer triggers the sensing/resource selection procedure. Taking FIG. 4 as one example scenario, the PHY layer of UE-B 404 may trigger the sensing/resource selection procedure upon receiving an IUC message from UE-A 402. It should be noted that in this example the assumption is that UE-B 404 requests UE-A 402 to send some IUC message by some explicit request 406, e.g., explicit request message.

When performing the sensing/resource selection procedure, e.g., determining some set of candidate resources for SL transmission(s), UE-A/PHY considers the IUC information received from UE-A 402. To ensure that a SL transmission is sent to UE-A 402 when using the IUC information from UE-A 402, PHY indicates to MAC layer that IUC from UE-A 402 was taking into account for the sensing/resource selection procedure. Correspondingly, the MAC would set the destination to the destination ID of UE-A 402 while performing the LCP procedure respectively when generating the transport block for transmission according to the set of candidate resource provided by PHY. Since MAC layer does not select a destination according to logical channel priority but instead skips the destination selection step during LCP and sets the destination directly to the destination ID of UE-A402, it ensured that SL TB(s) will be generated for UE-A 402.

In the legacy LCP procedure, UE/MAC selects a destination associated with one of unicast, groupcast, and broadcast having at least one of the MAC CE and the logical channel with the highest priority, among the logical channels that satisfy all the following conditions and MAC CE(s), if any, for the SL grant associated to the SCI. It should be noted that the remaining steps of the LCP procedure are according to this embodiment done as in the legacy LCP procedure, i.e., only the first step “destination selection” is different compared to the legacy LCP procedure. Also, when performing the LCP procedure for “reserved” resources, i.e., future SL resources which are indicated in the SCI as reserved resources, UE/MAC uses according to this embodiment during the LCP procedure the destination, whose IUC information were considered during the sending/resource selection procedure. Similarly, as described above, MAC will skip the selection of the destination, but instead sets the Destination to the destination ID of the IUC information which was taken into account during the sensing/resource selection procedure when performing an LCP procedure.

According to a further embodiment, the MAC layer indicates to the PHY the destination ID and associated IUC message/information received from the destination, which PHY should take into account when performing the sensing/resource selection procedure. According to one implementation of this embodiment, MAC layer of the UE triggers the resource selection procedure. In a first step UE/MAC performs some “crude” LCP procedure, e.g., the UE selects a destination thereby considering the logical channel priority of the LCHs or MAC CE(s) (UE selects the destination having at least one of the MAC CE and the logical channel with the highest priority, among the logical channels that satisfy all the following conditions and MAC CE(s)). Based on the selected destination, MAC layer informs the PHY about the selected destination and potentially IUC information received for the selected destination. PHY will then perform the sensing/resource selection procedure thereby considering the IUC information received from MAC. When resource candidates are indicated from PHY to MAC as a result of the sensing/resource selection procedure, MAC performs the regular LCP procedure. According to one implementation of the embodiment, MAC uses the already selected destination for the LCP procedure, e.g., UE doesn't perform a destination selection as part of the LCP procedure, which is normally performed in the legacy LCP procedure.

According to one aspect of the embodiment, PHY informs MAC layer when indicating the set of resource candidates as a result of the sensing/resource selection procedure the destination of the IUC information (if any) which was considered during sensing/resource selection. MAC will take the indicated destination as an input for the LCP procedure. In one example UE will use the indicated destination for the selection of logical channels and the allocation of sidelink resource during LCP. To be more specific, MAC will skip the “destination selection” within the LCP procedure and use the destination as indicated by PHY for the further steps of the LCP procedure.

According to one further embodiment, UE triggers the transmission of an IUC message based on a received request message. In one example the IUC request is signaled within a SCI. According to one specific implementation the UE triggers the transmission of an IUC message when receiving a CSI request signaling within the SCI. Upon the reception of a IUC request, MAC triggers the transmission of an IUC message to the destination from which the request was received. In one implementation the IUC information is signaled within a new MAC CE. According to some further aspects of the embodiment, the UE triggers the transmission of an IUC message based on some predefined trigger conditions.

In one example, the UE is configured with an IUC-related reporting configuration indicating for example a periodicity. UE should trigger the transmission of a IUC report according to the configured periodicity. Similar to the periodic BSR reporting, UE has in one implementation of this embodiment a timer which controls the periodic transmission of a IUC report/message. Referring to the scenario in FIG. 4, UE-B 404 may send an IUC-related configuration to UE-A 402, e.g., UE-B 404 configures UE-A 402 with an IUC periodicity. According to a further implementation of the embodiment, the UE may trigger the transmission of an IUC report in case of a significant path loss change, e.g., path loss has changed more than a configured threshold. In another example, the UE triggers the transmission of an IUC report for cases when the CBR changes more than a predefined threshold.

In one specific implementation, the UE autonomously triggers an IUC report based on some predefined trigger conditions if the SL LCHs have an associated logical channel priority which is higher than a predefined threshold, e.g., there is at least one SL LCH with a logical channel priority being greater than a preconfigured threshold. In another example, a UE is configured with a set of destination for which UE should trigger a IUC report based on some predefined trigger conditions.

According to one embodiment, a UE uses a predefined reference format for the generation of an IUC report for cases when the IUC report was triggered by the UE itself based on some predefined trigger conditions. In one implementation of the embodiment, the UE generates the report including some predefined IUC type information, e.g., reporting of “preferred” resources and/or “not preferred resources” according to the reference format. Furthermore, the UE may generate the IUC report for some predefined number of subchannels and/or predefined priority and/or time period according to the reference format when autonomously triggering an IUC report to a destination. It should be noted that in case UE receives an explicit IUC request, e.g., SCI, from a destination, the IUC request may contain information such as the number of subchannels, priority, type of IUC information requested (preferred resources/not preferred resources) and timing information (start time and end time).

According to one implementation of the embodiment, the reference format based on which UE generates a IUC report for cases when the IUC is self-triggered by the UE, e.g., no explicit request by other UE, is defined per resource pool. In one specific implementation of the embodiment, the time window, e.g., Tₛₜₐᵣₜ/T_{end} is configured per resource pool.

According to one embodiment, the priority of an IUC report, respectively the priority of a IUC MAC CE conveying the IUC report, is considered as the highest priority during LCP procedure, e.g., during destination selection and allocation of sidelink resources among the selected LCHs. In one implementation of this embodiment, the UE considers during LCP procedure the priority of the IUC MAC as the priority indicated in the corresponding IUC request (e.g., SCI). In a further implementation of this embodiment, UE uses a predefined priority for an IUC MAC CE during LCP procedure for cases when the IUC MAC CE was triggered autonomously by a UE based on some predefined trigger conditions.

According to one embodiment, UE/MAC sets the latency bound for the transmission of a SL-IUC MAC CE to the start time, e.g., Tₛₜₐᵣₜ, signaled within the corresponding IUC request (e.g., SCI). In one implementation of the embodiment MAC entity maintains a sl-IUC-ReportTimer for each pair of the Source Layer-2 ID and the Destination Layer-2 ID corresponding to a PC5-RRC connection. sl-IUC-ReportTimer is used for a SL-IUC reporting UE to follow the latency requirement signaled from a UIC triggering UE. The value of sl-IUC-ReportTimer is the same as the latency requirement of the SL-IUC reporting in IUC request, e.g., Tₛₜₐᵣₜ. In another implementation of the embodiment, the latency bound for the transmission of an SL-IUC MAC CE is set to the end Time, e.g., T_{end}, signaled within the corresponding IUC request (SCI). Accordingly sets the sl-IUC-ReportTimer value to T_{end}. According to one further aspect of this embodiment, UE/MAC uses a preconfigured latency bound for the transmission of a SL-IUC MAC CE, e.g. for cases when the IUC MAC CE was autonomously triggered by the UE based on some predefine trigger conditions.

According to one embodiment, UE/MAC cancels the transmission of a triggered IUC report to the IUC-requesting UE for cases when the IUC report is outdated, e.g. IUC report has not been successfully transmitted before the end of the resource selection window, e.g., T_{end}, for which IUC information were generated in the IUC report is elapsed.

Since the receiver of the IUC report cannot use the provided IUC information if the provided information is already outdated, UE should cancel the transmission of the IUC report.

According to one embodiment, UE/MAC maintains an SL-IUC-prohibitTimer, which controls the rate of self-triggered IUC reports. MAC starts the timer upon transmission/triggering of an IUC report which was autonomously triggered by the UE based on some predefined conditions. While the timer is running UE/MAC is not allowed to trigger a new IUC report. The purpose of such SL-IUC-prohibitTimer is to avoid excessive signaling of IUC reports.

According to one embodiment, an IUC report contains information about which type of IUC information is contained within the report. According to one implementation of this embodiment an IUC report is transmitted via a MAC CE. In one example the MAC CE contains some information indicating which type of IUC information/which IUC scheme is included within the MAC CE, e.g., MAC CE contains a “preferred resource set” and/or a “non-preferred resource sct.” Such information indicating the type of IUC information conveyed within the MAC CE is in one example carried within the MAC header. According to one implementation of the embodiment, different types of IUC MAC CEs are introduced for the purpose of IUC information reporting. In one example, an IUC MAC CE consists of either a full IUC report format (variable size) or a truncated IUC report format (variable size). For cases that a IUC MAC CE has been triggered and the number of bits in a SL grant is expected to be equal to or larger than the size of an IUC MAC CE consisting of a full IUC report plus the subheader of the IUC MAC CE, UE includes a full IUC report MAC CE: otherwise, it will multiplex a truncated IUC report MAC CE into the SL grant. According to one implementation of the embodiment, UE doesn't cancel a triggered IUC report for cases when UE transmitted a truncated IUC report MAC CE, e.g., SL resources were not sufficient for reporting the full IUC information. UE will according to one implementation transmit the remaining, e.g., not yet transmitted IUC information, in a subsequent SL transmission.

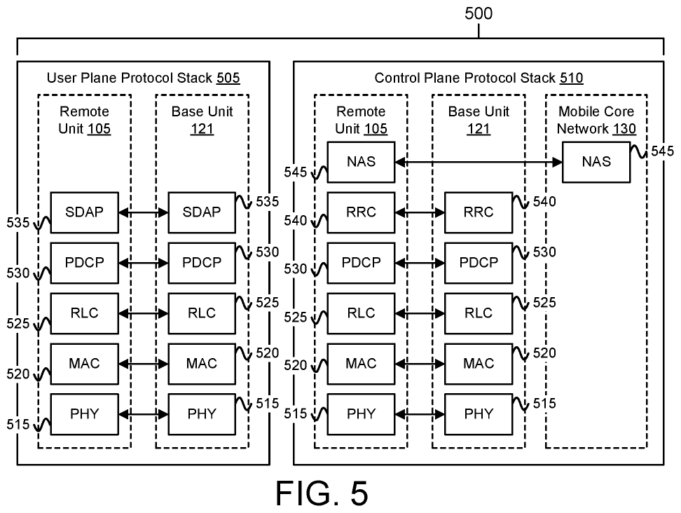

FIG. 5 depicts a NR protocol stack 500, according to embodiments of the disclosure. While FIG. 5 shows the remote unit 105, the base unit 121 and the mobile core network 130, these are representative of a set of UEs interacting with a RAN node and a NF (e.g., AMF) in a core network. As depicted, the protocol stack 500 comprises a User Plane protocol stack 505 and a Control Plane protocol stack 510. The User Plane protocol stack 505 includes a physical (“PHY”) layer 515, a Medium Access Control (“MAC”) sublayer 520, a Radio Link Control (“RLC”) sublayer 525, a Packet Data Convergence Protocol (“PDCP”) sublayer 530, and Service Data Adaptation Protocol (“SDAP”) layer 535. The Control Plane protocol stack 510 also includes a PHY layer 515, a MAC sublayer 520, a RLC sublayer 525, and a PDCP sublayer 530. The Control Plane protocol stack 510 also includes a Radio Resource Control (“RRC”) sublayer 540 and a Non-Access Stratum (“NAS”) sublayer 545.

The AS protocol stack for the Control Plane protocol stack 510 consists of at least RRC, PDCP, RLC and MAC sublayers, and the physical layer. The AS protocol stack for the User Plane protocol stack 505 consists of at least SDAP, PDCP, RLC and MAC sublayers, and the physical layer. The Layer-2 (“L2”) is split into the SDAP, PDCP, RLC and MAC sublayers. The Layer-3 (“L3”) includes the RRC sublayer 540 and the NAS layer 545 for the control plane and includes, e.g., an Internet Protocol (“IP”) layer or PDU Layer (note depicted) for the user plane. L1 and L2 are referred to as “lower layers” such as PUCCH/PUSCH or MAC CE, while L3 and above (e.g., transport layer, application layer) are referred to as “higher layers” or “upper layers” such as RRC.

The physical layer 515 offers transport channels to the MAC sublayer 520. The MAC sublayer 520 offers logical channels to the RLC sublayer 525. The RLC sublayer 525 offers RLC channels to the PDCP sublayer 530. The PDCP sublayer 530 offers radio bearers to the SDAP sublayer 535 and/or RRC layer 540. The SDAP sublayer 535 offers QoS flows to the mobile core network 130 (e.g., 5GC). The RRC layer 540 provides for the addition, modification, and release of Carrier Aggregation and/or Dual Connectivity. The RRC sublayer 540 also manages the establishment, configuration, maintenance, and release of Signaling Radio Bearers (“SRBs”) and Data Radio Bearers (“DRBs”). In certain embodiments, a RRC entity functions for detection of and recovery from radio link failure.

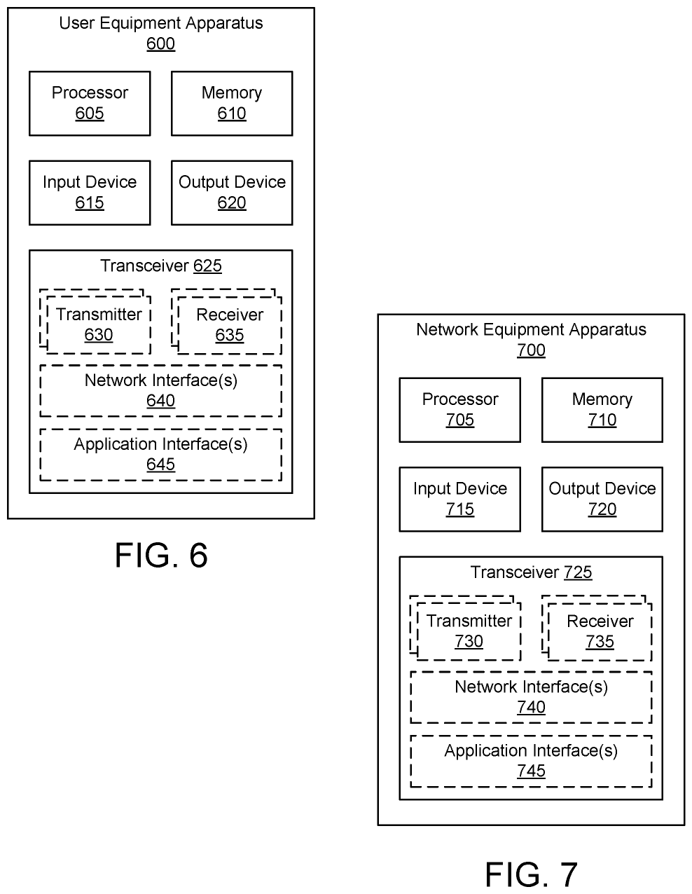

FIG. 6 depicts a UE apparatus 600 that may be used for LCP procedure considering IUC schemes, according to embodiments of the disclosure. In various embodiments, the UE apparatus 600 is used to implement one or more of the solutions described above. The UE apparatus 600 may be one embodiment of a UE, such as the remote unit 105 and/or the UE 205, as described above. Furthermore, the UE apparatus 600 may include a processor 605, a memory 610, an input device 615, an output device 620, and a transceiver 625. In some embodiments, the input device 615 and the output device 620 are combined into a single device, such as a touchscreen. In certain embodiments, the UE apparatus 600 may not include any input device 615 and/or output device 620. In various embodiments, the UE apparatus 600 may include one or more of: the processor 605, the memory 610, and the transceiver 625, and may not include the input device 615 and/or the output device 620.

As depicted, the transceiver 625 includes at least one transmitter 630 and at least one receiver 635. Here, the transceiver 625 communicates with one or more base units 121. Additionally, the transceiver 625 may support at least one network interface 640 and/or application interface 645. The application interface(s) 645 may support one or more APIs. The network interface(s) 640 may support 3GPP reference points, such as Uu and PC5. Other network interfaces 640 may be supported, as understood by one of ordinary skill in the art.

The processor 605, in one embodiment, may include any known controller capable of executing computer-readable instructions and/or capable of performing logical operations. For example, the processor 605 may be a microcontroller, a microprocessor, a central processing unit (“CPU”), a graphics processing unit (“GPU”), an auxiliary processing unit, a field programmable gate array (“FPGA”), a digital signal processor (“DSP”), a co-processor, an application-specific processor, or similar programmable controller. In some embodiments, the processor 605 executes instructions stored in the memory 610 to perform the methods and routines described herein. The processor 605 is communicatively coupled to the memory 610, the input device 615, the output device 620, and the transceiver 625. In certain embodiments, the processor 605 may include an application processor (also known as “main processor”) which manages application-domain and operating system (“OS”) functions and a baseband processor (also known as “baseband radio processor”) which manages radio functions.

The memory 610, in one embodiment, is a computer readable storage medium. In some embodiments, the memory 610 includes volatile computer storage media. For example, the memory 610 may include a RAM, including dynamic RAM (“DRAM”), synchronous dynamic RAM (“SDRAM”), and/or static RAM (“SRAM”). In some embodiments, the memory 610 includes non-volatile computer storage media. For example, the memory 610 may include a hard disk drive, a flash memory, or any other suitable non-volatile computer storage device. In some embodiments, the memory 610 includes both volatile and non-volatile computer storage media.

In some embodiments, the memory 610 stores data related to LCP procedure considering IUC schemes. For example, the memory 610 may store parameters, configurations, resource assignments, policies, and the like as described above. In certain embodiments, the memory 610 also stores program code and related data, such as an operating system or other controller algorithms operating on the UE apparatus 600, and one or more software applications.

The input device 615, in one embodiment, may include any known computer input device including a touch panel, a button, a keyboard, a stylus, a microphone, or the like. In some embodiments, the input device 615 may be integrated with the output device 620, for example, as a touchscreen or similar touch-sensitive display. In some embodiments, the input device 615 includes a touchscreen such that text may be input using a virtual keyboard displayed on the touchscreen and/or by handwriting on the touchscreen. In some embodiments, the input device 615 includes two or more different devices, such as a keyboard and a touch panel.

The output device 620, in one embodiment, is designed to output visual, audible, and/or haptic signals. In some embodiments, the output device 620 includes an electronically controllable display or display device capable of outputting visual data to a user. For example, the output device 620 may include, but is not limited to, an LCD display, an LED display, an OLED display, a projector, or similar display device capable of outputting images, text, or the like to a user. As another, non-limiting, example, the output device 620 may include a wearable display separate from, but communicatively coupled to, the rest of the UE apparatus 600, such as a smart watch, smart glasses, a heads-up display, or the like. Further, the output device 620 may be a component of a smart phone, a personal digital assistant, a television, a table computer, a notebook (laptop) computer, a personal computer, a vehicle dashboard, or the like.

In certain embodiments, the output device 620 includes one or more speakers for producing sound. For example, the output device 620 may produce an audible alert or notification (e.g., a beep or chime). In some embodiments, the output device 620 includes one or more haptic devices for producing vibrations, motion, or other haptic feedback. In some embodiments, all, or portions of the output device 620 may be integrated with the input device 615. For example, the input device 615 and output device 620 may form a touchscreen or similar touch-sensitive display. In other embodiments, the output device 620 may be located near the input device 615.

The transceiver 625 includes at least transmitter 630 and at least one receiver 635. The transceiver 625 may be used to provide UL communication signals to a base unit 121 and to receive DL communication signals from the base unit 121, as described herein. Similarly, the transceiver 625 may be used to transmit and receive SL signals (e.g., V2X communication), as described herein. Although only one transmitter 630 and one receiver 635 are illustrated, the UE apparatus 600 may have any suitable number of transmitters 630 and receivers 635. Further, the transmitter(s) 630 and the receiver(s) 635 may be any suitable type of transmitters and receivers. In one embodiment, the transceiver 625 includes a first transmitter/receiver pair used to communicate with a mobile communication network over licensed radio spectrum and a second transmitter/receiver pair used to communicate with a mobile communication network over unlicensed radio spectrum.

In certain embodiments, the first transmitter/receiver pair used to communicate with a mobile communication network over licensed radio spectrum and the second transmitter/receiver pair used to communicate with a mobile communication network over unlicensed radio spectrum may be combined into a single transceiver unit, for example a single chip performing functions for use with both licensed and unlicensed radio spectrum. In some embodiments, the first transmitter/receiver pair and the second transmitter/receiver pair may share one or more hardware components. For example, certain transceivers 625, transmitters 630, and receivers 635 may be implemented as physically separate components that access a shared hardware resource and/or software resource, such as for example, the network interface 640.

In various embodiments, one or more transmitters 630 and/or one or more receivers 635 may be implemented and/or integrated into a single hardware component, such as a multi-transceiver chip, a system-on-a-chip, an ASIC, or other type of hardware component. In certain embodiments, one or more transmitters 630 and/or one or more receivers 635 may be implemented and/or integrated into a multi-chip module. In some embodiments, other components such as the network interface 640 or other hardware components/circuits may be integrated with any number of transmitters 630 and/or receivers 635 into a single chip. In such embodiment, the transmitters 630 and receivers 635 may be logically configured as a transceiver 625 that uses one more common control signals or as modular transmitters 630 and receivers 635 implemented in the same hardware chip or in a multi-chip module.

In one embodiment, the processor 605 is configured to determine a latency bound for transmission of a SL IUC report via a MAC CE, maintain a report timer for transmitting the IUC report via the MAC CE according to the determined latency bound, and transmit the IUC information via the MAC CE based on the report timer.

In one embodiment, the latency bound is based on a start time received in an SCI request for the SL IUC report.

In one embodiment, the latency bound is based on an end time received in an SCI request for the SL IUC report.

In one embodiment, the apparatus 600 is preconfigured with the latency bound.

In one embodiment, the IUC report comprises information indicating a type of IUC information that is contained in the IUC report.

In one embodiment, the MAC CE comprises information indicating the type of IUC information included within the MAC CE.

In one embodiment, the type of information within the IUC report comprises a preferred resource set, a non-preferred resource set, or a combination thereof.

In one embodiment, the processor 605 is configured to maintain the report timer for each pair of a source layer-2 identifier and a destination layer-2 identifier corresponding to a PC5-RRC connection.

In one embodiment, the processor 605 is configured to continue to attempt to transmit the MAC CE comprising the IUC information until expiration of the report timer.

In one embodiment, different types of MAC CEs comprising IUC information are used for IUC information reporting.

In one embodiment, a MAC CE comprises a full IUC report format or a truncated IUC report format.

In one embodiment, the processor 605 is configured to include a full IUC report in the MAC CE in response to a number of bits in an SL configured grant expected to be equal to or greater than a size of the MAC CE comprising the full IUC report and a subheader of the MAC CE.

In one embodiment, the processor 605 is configured to multiplex a MAC CE comprising a truncated IUC report into a SL configured grant in response to a number of bits in the SL configured grant expected to be less than a size of the MAC CE comprising a full IUC report and a subheader of the MAC CE.

In one embodiment, the processor 605 is configured to transmit remaining IUC report information of a truncated IUC report in a subsequent SL transmission in response to SL resources not being sufficient for reporting a full IUC report.

FIG. 7 depicts one embodiment of a network apparatus 700 that may be used for LCP procedure considering IUC schemes, according to embodiments of the disclosure. In some embodiments, the network apparatus 700 may be one embodiment of a RAN node and its supporting hardware, such as the base unit 121 and/or gNB, described above. Furthermore, network apparatus 700 may include a processor 705, a memory 710, an input device 715, an output device 720, and a transceiver 725. In certain embodiments, the network apparatus 700 does not include any input device 715 and/or output device 720.

As depicted, the transceiver 725 includes at least one transmitter 730 and at least one receiver 735. Here, the transceiver 725 communicates with one or more remote units 105. Additionally, the transceiver 725 may support at least one network interface 740 and/or application interface 745. The application interface(s) 745 may support one or more APIs. The network interface(s) 740 may support 3GPP reference points, such as Uu, N1, N2, N3, N5, N6 and/or N7 interfaces. Other network interfaces 740 may be supported, as understood by one of ordinary skill in the art.

When implementing an NEF, the network interface(s) 740 may include an interface for communicating with an application function (i.e., N5) and with at least one network function (e.g., UDR, SFC function, UPF) in a mobile communication network, such as the mobile core network 130.

The processor 705, in one embodiment, may include any known controller capable of executing computer-readable instructions and/or capable of performing logical operations. For example, the processor 705 may be a microcontroller, a microprocessor, a CPU, a GPU, an auxiliary processing unit, an FPGA, a DSP, a co-processor, an application-specific processor, or similar programmable controller. In some embodiments, the processor 705 executes instructions stored in the memory 710 to perform the methods and routines described herein. The processor 705 is communicatively coupled to the memory 710, the input device 715, the output device 720, and the transceiver 725. In certain embodiments, the processor 705 may include an application processor (also known as “main processor”) which manages application-domain and OS functions and a baseband processor (also known as “baseband radio processor”) which manages radio function. In various embodiments, the processor 705 controls the network apparatus 700 to implement the above described network entity behaviors (e.g., of the gNB) for restriction on the usage of IUC schemes during congestions.

The memory 710, in one embodiment, is a computer readable storage medium. In some embodiments, the memory 710 includes volatile computer storage media. For example, the memory 710 may include a RAM, including DRAM, SDRAM, and/or SRAM. In some embodiments, the memory 710 includes non-volatile computer storage media. For example, the memory 710 may include a hard disk drive, a flash memory, or any other suitable non-volatile computer storage device. In some embodiments, the memory 710 includes both volatile and non-volatile computer storage media.

In some embodiments, the memory 710 stores data relating to LCP procedure considering IUC schemes. For example, the memory 710 may store parameters, configurations, resource assignments, policies, and the like as described above. In certain embodiments, the memory 710 also stores program code and related data, such as an operating system (“OS”) or other controller algorithms operating on the network apparatus 700, and one or more software applications.

The input device 715, in one embodiment, may include any known computer input device including a touch panel, a button, a keyboard, a stylus, a microphone, or the like. In some embodiments, the input device 715 may be integrated with the output device 720, for example, as a touchscreen or similar touch-sensitive display. In some embodiments, the input device 715 includes a touchscreen such that text may be input using a virtual keyboard displayed on the touchscreen and/or by handwriting on the touchscreen. In some embodiments, the input device 715 includes two or more different devices, such as a keyboard and a touch panel.

The output device 720, in one embodiment, may include any known electronically controllable display or display device. The output device 720 may be designed to output visual, audible, and/or haptic signals. In some embodiments, the output device 720 includes an electronic display capable of outputting visual data to a user. Further, the output device 720 may be a component of a smart phone, a personal digital assistant, a television, a table computer, a notebook (laptop) computer, a personal computer, a vehicle dashboard, or the like.

In certain embodiments, the output device 720 includes one or more speakers for producing sound. For example, the output device 720 may produce an audible alert or notification (e.g., a beep or chime). In some embodiments, the output device 720 includes one or more haptic devices for producing vibrations, motion, or other haptic feedback. In some embodiments, all, or portions of the output device 720 may be integrated with the input device 715. For example, the input device 715 and output device 720 may form a touchscreen or similar touch-sensitive display. In other embodiments, all, or portions of the output device 720 may be located near the input device 715.

As discussed above, the transceiver 725 may communicate with one or more remote units and/or with one or more interworking functions that provide access to one or more PLMNs. The transceiver 725 may also communicate with one or more network functions (e.g., in the mobile core network 80). The transceiver 725 operates under the control of the processor 705 to transmit messages, data, and other signals and also to receive messages, data, and other signals. For example, the processor 705 may selectively activate the transceiver (or portions thereof) at particular times in order to send and receive messages.

The transceiver 725 may include one or more transmitters 730 and one or more receivers 735. In certain embodiments, the one or more transmitters 730 and/or the one or more receivers 735 may share transceiver hardware and/or circuitry. For example, the one or more transmitters 730 and/or the one or more receivers 735 may share antenna(s), antenna tuner(s), amplifier(s), filter(s), oscillator(s), mixer(s), modulator/demodulator(s), power supply, and the like. In one embodiment, the transceiver 725 implements multiple logical transceivers using different communication protocols or protocol stacks, while using common physical hardware.

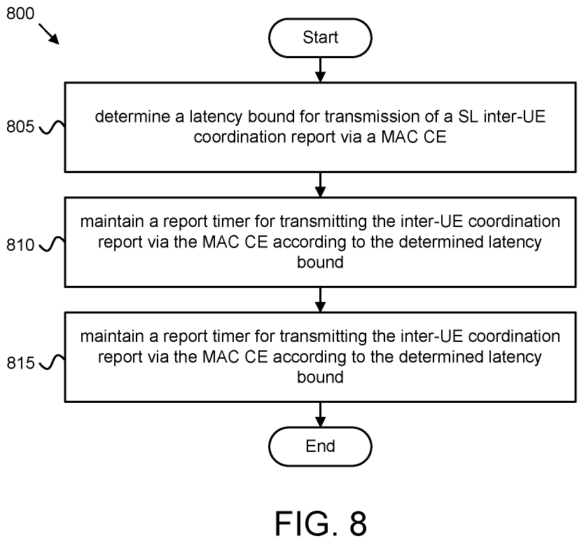

FIG. 8 is a flowchart diagram of a method 800 for LCP procedure considering IUC schemes. The method 800 may be performed by a UE as described herein, for example, the remote unit 105 and/or the UE apparatus 600. In some embodiments, the method 800 may be performed by a processor executing program code, for example, a microcontroller, a microprocessor, a CPU, a GPU, an auxiliary processing unit, a FPGA, or the like.

In one embodiment, the method 800 begins and determines 805, at a UE apparatus, a latency bound for transmission of a SL IUC report via a MAC CE, maintains 810 a report timer for transmitting the IUC report via the MAC CE according to the determined latency bound, and transmits 815 the IUC information via the MAC CE based on the report timer, and the method 800 ends.

A first apparatus is disclosed for LCP procedure considering IUC schemes. The first apparatus may include a UE as described herein, for example, the remote unit 105 and/or the UE apparatus 600. In some embodiments, the first apparatus includes a processor executing program code, for example, a microcontroller, a microprocessor, a CPU, a GPU, an auxiliary processing unit, an FPGA, or the like.

In one embodiment, the first apparatus includes a memory and a processor coupled to the memory. In one embodiment, the processor is configured to cause the apparatus to determine a latency bound for transmission of a SL inter-UE coordination report via a MAC CE, maintain a report timer for transmitting the inter-UE coordination report via the MAC CE according to the determined latency bound, and transmit the inter-UE coordination information via the MAC CE based on the report timer.

In one embodiment, the latency bound is based on a start time received in an SCI request for the SL inter-UE coordination report.

In one embodiment, the latency bound is based on an end time received in an SCI request for the SL inter-UE coordination report.

In one embodiment, the apparatus is preconfigured with the latency bound.

In one embodiment, the inter-UE coordination report comprises information indicating a type of inter-UE coordination information that is contained in the inter-UE coordination report.

In one embodiment, the MAC CE comprises information indicating the type of inter-UE coordination information included within the MAC CE.

In one embodiment, the type of information within the inter-UE coordination report comprises a preferred resource set, a non-preferred resource set, or a combination thereof.

In one embodiment, the processor is configured to cause the apparatus to maintain the report timer for each pair of a source layer-2 identifier and a destination layer-2 identifier corresponding to a PC5-RRC connection.

In one embodiment, the processor is configured to cause the apparatus to continue to attempt to transmit the MAC CE comprising the inter-UE coordination information until expiration of the report timer.

In one embodiment, different types of MAC CEs comprising inter-UE coordination information are used for inter-UE coordination information reporting.

In one embodiment, a MAC CE comprises a full inter-UE coordination report format or a truncated inter-UE coordination report format.

In one embodiment, the processor is configured to cause the apparatus to include a full inter-UE coordination report in the MAC CE in response to a number of bits in an SL configured grant expected to be equal to or greater than a size of the MAC CE comprising the full inter-UE coordination report and a subheader of the MAC CE.

In one embodiment, the processor is configured to cause the apparatus to multiplex a MAC CE comprising a truncated inter-UE coordination report into a SL configured grant in response to a number of bits in the SL configured grant expected to be less than a size of the MAC CE comprising a full inter-UE coordination report and a subheader of the MAC CE.

In one embodiment, the processor is configured to cause the apparatus to transmit remaining inter-UE coordination report information of a truncated inter-UE coordination report in a subsequent SL transmission in response to SL resources not being sufficient for reporting a full inter-UE coordination report.

A first method is disclosed for LCP procedure considering IUC schemes. The first method may be performed by a UE as described herein, for example, the remote unit 105 and/or the UE apparatus 600. In some embodiments, the first method may be performed by a processor executing program code, for example, a microcontroller, a microprocessor, a CPU, a GPU, an auxiliary processing unit, an FPGA, or the like.

In one embodiment, the first method determines, at a UE apparatus, a latency bound for transmission of a SL inter-UE coordination report via a MAC CE, maintains a report timer for transmitting the inter-UE coordination report via the MAC CE according to the determined latency bound, and transmits the inter-UE coordination information via the MAC CE based on the report timer.

In one embodiment, the latency bound is based on a start time received in an SCI request for the SL inter-UE coordination report.

In one embodiment, the latency bound is based on an end time received in an SCI request for the SL inter-UE coordination report.

In one embodiment, the UE apparatus is preconfigured with the latency bound.

In one embodiment, the inter-UE coordination report comprises information indicating a type of inter-UE coordination information that is contained in the inter-UE coordination report.

In one embodiment, the MAC CE comprises information indicating the type of inter-UE coordination information included within the MAC CE.

In one embodiment, the type of information within the inter-UE coordination report comprises a preferred resource set, a non-preferred resource set, or a combination thereof.

In one embodiment, the first method maintains the report timer for each pair of a source layer-2 identifier and a destination layer-2 identifier corresponding to a PC5-RRC connection.

In one embodiment, the first method continues to attempt to transmit the MAC CE comprising the inter-UE coordination information until expiration of the report timer.

In one embodiment, different types of MAC CEs comprising inter-UE coordination information are used for inter-UE coordination information reporting.

In one embodiment, a MAC CE comprises a full inter-UE coordination report format or a truncated inter-UE coordination report format.

In one embodiment, the first method includes a full inter-UE coordination report in the MAC CE in response to a number of bits in an SL configured grant expected to be equal to or greater than a size of the MAC CE comprising the full inter-UE coordination report and a subheader of the MAC CE.

In one embodiment, the first method multiplexes a MAC CE comprising a truncated inter-UE coordination report into a SL configured grant in response to a number of bits in the SL configured grant expected to be less than a size of the MAC CE comprising a full inter-UE coordination report and a subheader of the MAC CE.

In one embodiment, the first method transmits remaining inter-UE coordination report information of a truncated inter-UE coordination report in a subsequent SL transmission in response to SL resources not being sufficient for reporting a full inter-UE coordination report.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. An apparatus, comprising:
a memory; and
a processor coupled to the memory, the processor configured to cause the apparatus to:
determine a latency bound for transmission of a sidelink (“SL”) inter-user equipment (“UE”) coordination report via a medium access control (“MAC”) control element (“CE”):
maintain a report timer for transmitting the inter-UE coordination report via the MAC CE according to the determined latency bound; and
transmit the inter-UE coordination information via the MAC CE based on the report timer.

2. The apparatus of claim 1, wherein the latency bound is based on a start time received in a sidelink control information (“SCI”) request for the SL inter-UE coordination report.

3. The apparatus of claim 1, wherein the latency bound is based on an end time received in a sidelink control information (“SCI”) request for the SL inter-UE coordination report.

4. The apparatus of claim 1, wherein the apparatus is preconfigured with the latency bound.

5. The apparatus of claim 1, wherein the inter-UE coordination report comprises information indicating a type of inter-UE coordination information that is contained in the inter-UE coordination report.

6. The apparatus of claim 5, wherein the MAC CE comprises information indicating the type of inter-UE coordination information included within the MAC CE.

7. The apparatus of claim 6, wherein the type of information within the inter-UE coordination report comprises a preferred resource set, a non-preferred resource set, or a combination thereof.

8. The apparatus of claim 1, wherein the processor is configured to cause the apparatus to maintain the report timer for each pair of a source layer-2 identifier and a destination layer-2 identifier corresponding to a PC5-radio resource control (“RRC”) connection.

9. The apparatus of claim 1, wherein the processor is configured to cause the apparatus to continue to attempt to transmit the MAC CE comprising the inter-UE coordination information until expiration of the report timer.

10. The apparatus of claim 1, wherein different types of MAC CEs comprising inter-UE coordination information are used for inter-UE coordination information reporting.

11. The apparatus of claim 1, wherein a MAC CE comprises a full inter-UE coordination report format or a truncated inter-UE coordination report format.

12. The apparatus of claim 1, wherein the processor is configured to cause the apparatus to include a full inter-UE coordination report in the MAC CE in response to a number of bits in an SL configured grant expected to be equal to or greater than a size of the MAC CE comprising the full inter-UE coordination report and a subheader of the MAC CE.

13. The apparatus of claim 1, wherein the processor is configured to cause the apparatus to multiplex a MAC CE comprising a truncated inter-UE coordination report into a SL configured grant in response to a number of bits in the SL configured grant expected to be less than a size of the MAC CE comprising a full inter-UE coordination report and a subheader of the MAC CE.

14. The apparatus of claim 13, wherein the processor is configured to cause the apparatus to transmit remaining inter-UE coordination report information of a truncated inter-UE coordination report in a subsequent SL transmission in response to SL resources not being sufficient for reporting a full inter-UE coordination report.

15. A method, comprising:
determining, at a user equipment (“UE”) apparatus, a latency bound for transmission of a sidelink (“SL”) inter-UE coordination report via a medium access control (“MAC”) control element (“CE”);
maintaining a report timer for transmitting the inter-UE coordination report via the MAC CE according to the determined latency bound; and
transmitting the inter-UE coordination information via the MAC CE based on the report timer.
